(19) United States
(12) Patent Application Publication
(10) Pub. No.: US 2012/0198704 A1
(43) Pub. Date: Aug. 9, 2012

(54) Apparatus for Trimming Toilet Anchor Bolts

(76) Inventors: Norman L. Cosier, Las Vegas, NV (US); Stanley K. Cosier, Spring Lake, NC (US)

(21) Appl. No.: 13/020,554

(22) Filed: Feb. 3, 2011

(51) Int. Cl. B26B 17/02; B26B 17/00

(52) U.S. Cl. 30/186; 30/270

(57) ABSTRACT

An apparatus includes a pair of handles in which each handle comprises a tab extending from a top of the handle. The handles are rotatably joined at the tabs. A two-piece fulcrum transfers a force from the pair of handles. Each piece comprises a bottom portion for rotatably joining to a one of the handles, a top portion and an arm extending from the piece for rotatably joining the pieces. A two-piece head forms a craw in which each piece comprises a bottom portion rotatably joined to the top portion of fulcrum and a blade having an indentation for engaging an anchor bolt of a floor toilet. A pivot point lever rotatably joins the pieces, generally aligns the blades and transfers forces from the fulcrum to a cutting force on the bolt where a length of the bolt can be cut while mitigating damage to a thread of the anchor bolt.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to tools. More particularly, the invention relates to a cutting device for toilet anchor bolts.

### BACKGROUND OF THE INVENTION

Toilet installation and replacement is not exactly a complicated task. To remove an old or broken toilet, one turns off the water to the existing toilet, empties the tank and bowl, disconnects the water line, and then unfastens the nuts from the anchor bolts. To install a new toilet, one replaces an O-ring or two and performs the tasks for removing a toilet in reverse. However, even though installing a new toilet is not complicated, there are some difficulties that go along with this task. For example, without limitation, toilets are heavy and are commonly installed in tight and constricted spaces. Also, their installation often requires the use of heavy tools around fragile ceramic, which commonly results in errors that may be notable, visible errors.

One exemplary task requiring bulky tools is trimming the anchor, or “johnny,” bolts. These anchor bolts typically come in an extended length to accommodate the variety of depths there may be between a toilet base and its hosting anchor. This means that the anchor bolts must be trimmed after they are tightened with nuts in order to accommodate caps to cover the bolts. Applying a blade to trim the anchor bolts is not an easy task because of the limited space, and the installer may be stuck for an extended amount of time trying to trim the bolts with a saw or other tool that he cannot easily move in the small space. Furthermore, the tool can strike the toilet base, leaving scratches, chips and even cracks, thus damaging a new toilet right after its installation. The tool may also hit the wall, a baseboard, a nearby cabinet, or other items and cause damage. Even if no damage is caused, the installer still must clean up the dust and fragments of the bolts that collect on the floor and toilet base from sawing the bolts.

Trimming the anchor bolts is not only a time consuming and annoying task; it may also be a costly task. Damaged toilets and damaged walls, baseboards and cabinets cost money to repair and replace, and the cost of the time it takes to saw away at the anchor bolts may also add up. Plumbers make an average of $21.94 an hour, and can easily spend 30 minutes or more in the process of trimming the anchor bolts and cleaning up the dust afterwards. Furthermore, the task of trimming anchor bolts may cause pain or injury in the installer since the process of hacking away at the anchor bolts involves physically-demanding labor in an uncomfortable position while in a constrained area. This leaves plumbers subject to the most common labor injuries of their trade, which is repetitive strain injury (RSI) caused by continuous and repetitive motion, and continuous physical discomfort caused by performing labor while in an awkward posture. It leaves employers subject to the costs of compensation claims as well. It is therefore an objective of the present invention to provide improved means for trimming the anchor bolts of a toilet.

While products designed to provide anchor bolt cutting functions are commercially available, there are no products with the convenience, design, functionality, and methodology incorporated in some preferred embodiments of the present invention. There are small hacksaws that are currently available. There small size may make it a little easier to access the restricted area of anchor bolts in comparison to full size hacksaws. However, these small hacksaws still require an extreme amount of back-and-forth repetitive motion to complete the cut, and also require the user to maintain a constant saw line in order to protect the threads from damage. Using these smaller hacksaws is labor intensive, requires a steady hand and can easily damage the threads of anchor bolts. Currently available cutting snips are also less than adequate as they can easily slip off the anchor bolt as pressure is applied to their handles by the user. By slipping from the anchor bolt damage to the threads can occur and there is a slight risk of injury to the user. Also, cutting snips are not specifically designed to cut anchor bolts so they require a lot of manual strength from the user. Currently available bolt cutters are too large to use in the confined areas where anchor bolts are located. All of these currently available methods also pose risk of damage to the toilet and the surrounding area simply due to their size and/or the need for repetitive motion which can cause a tool to slip off the anchor bolt and hit and therefore damage the surrounding area.

In view of the foregoing, there is a need for improved techniques for providing a device that quickly and easily trims toilet anchor bolts.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate an exemplary bolt-cutting tool, in accordance with an embodiment of the present invention. FIG. 1A is a diagrammatic front view of the bolt-cutting tool in a closed position, and FIG. 1B is a diagrammatic front view of the bolt-cutting tool in an open position;

FIG. 2 is diagrammatic front view of an exemplary head portion of a bolt-cutting tool, in accordance with an embodiment of the present invention; and

FIG. 3 is a top perspective view of an exemplary center fulcrum point portion of a bolt-cutting tool, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus for trimming toilet anchor bolts is presented.

In one embodiment an apparatus includes means for operating the apparatus in which the operating means are rotatably joined, means for transferring a rotational force from the operating means, means for forming a craw joined to the transferring means and operable for engaging an anchor bolt of a floor toilet and means for generally aligning the craw and transferring forces from the transferring means to a cutting force on the anchor bolt where a length of the anchor bolt can be cut while mitigating damage to a thread of the anchor bolt.

In another embodiment an apparatus includes a pair of handles for operating the apparatus in which each handle comprises a length for grasping and a flat-planed tab extending perpendicularly from a top of the handle. The handles are rotatably joined proximate distal ends of the flat-planed tabs. A two-piece fulcrum transfers a rotational force from the pair of handles. Each piece comprises a bottom portion for rotatably joining to a one of the pair of handles proximate a proximal end of the flat-planed tab, a top portion and a near-centered arm extending perpendicularly from the piece. The pieces are rotatably joined proximate distal ends of the near-centered arms. A two-piece head forms a craw in which each piece comprises a bottom portion rotatably joined to the top portion of one piece of the two-piece fulcrum and an interior blade having an indentation operable for engaging an anchor bolt of a floor toilet. A pivot point lever rotatably joins the pieces of the two-piece head, generally aligns the interior blades and transfers forces from the two-piece fulcrum to a cutting force on the anchor bolt where a length of the anchor bolt can be cut while mitigating damage to a thread of the anchor bolt.

In another embodiment an apparatus includes a pair of handles for operating the apparatus in which each handle comprises a length for grasping, a sleeve covering a portion of the length and a flat-planed tab extending perpendicularly from a top of the handle. The handles are rotatably joined proximate distal ends of the flat-planed tabs. A two-piece fulcrum transfers a rotational force from the pair of handles. Each piece comprises a top surface, a bottom surface and one side wall forming a channel into which one of the pair of handles is joined proximate a proximal end of the flat-planed tab. Each piece further comprising a near-centered arm extending perpendicularly from the piece for rotatably joining the pieces proximate distal ends of the near-centered arms. A two-piece head forms a craw in which each piece comprises a bottom portion rotatably joined to the channel of one piece of the two-piece fulcrum, a rounded exterior sidewall and an interior blade having an indentation forming a diamond shape when the craw is closed and operable for engaging an anchor bolt of a floor toilet. A pivot point lever rotatably joins the pieces of the two-piece head below the indentations, generally aligns the interior blades and transfers forces from the two-piece fulcrum to a cutting force on the anchor bolt where a length of the anchor bolt can be cut while mitigating damage to a thread of the anchor bolt.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A preferred embodiment of the present invention and at least one variation thereof, provides a cutting tool that enables the anchor bolts of a floor toilet to be reduced to a needed length in a fast and easy manner despite spatial limitations and generally without risk of damage to the toilet.

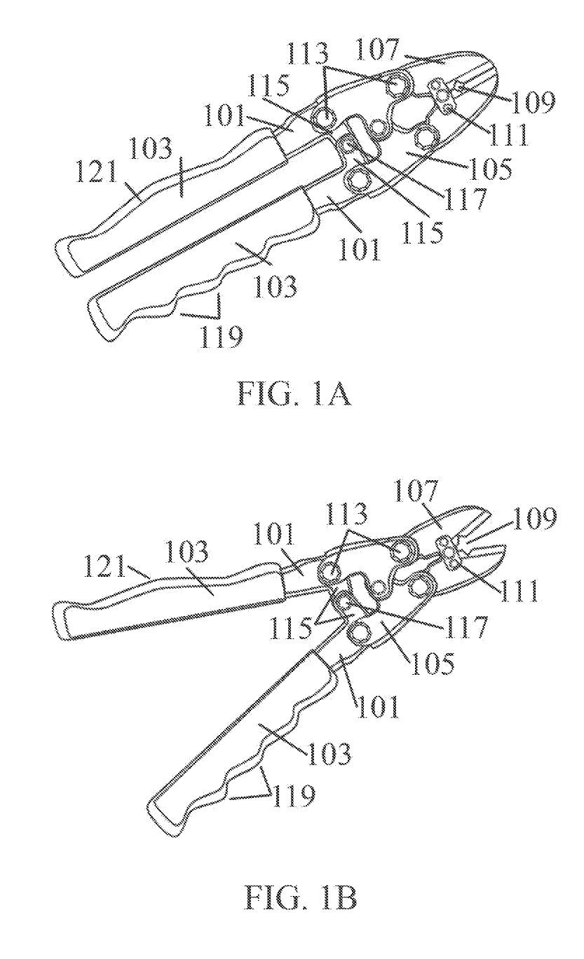

FIGS. 1A and 1B illustrate an exemplary bolt-cutting tool, in accordance with an embodiment of the present invention. FIG. 1A is a diagrammatic front view of the bolt-cutting tool in a closed position, and FIG. 1B is a diagrammatic front view of the bolt-cutting tool in an open position. In the present embodiment the bolt-cutting tool comprises ambidextrous handles 101, ergonomic insulating sleeves 103 about handles 101, a two-piece fulcrum 105 that mounts upon handles 101, and a two-piece head 107 that mounts upon fulcrum 105. Head 107 comprises blades with diamond-shaped indentations 109 of lateral alignment within the craw of two-piece head 107. Diamond-shaped indentations 109 are used for application upon the anchor bolts when cutting the length of these anchor bolts. A pivot point lever 111 is mounted upon corresponding walls of each portion of two-piece head 107. In the present embodiment, all portions of the bolt-cutting tool, except where noted, are made of alloyed steel, and various different steel alloys may be used, which may or may not include vanadium and/or chromium for improved strength and avoidance of rust corrosion. However, in alternate embodiments various different types of materials may be used such as, but not limited to, different types of metal, plastic, composite materials, etc. Furthermore, in some alternate embodiments, the elements may be made of a combination of materials. For example, without limitation, the handles may be made of plastic while the head and fulcrum are made of stainless steel. In the present embodiment, the separate portions of the bolt-cutting tool are attached to each other by nuts and bolts 113. However, in alternate embodiments, the separate portions of the bolt-cutting tool may be attached using various different fastening mechanisms such as, but not limited to, cotter pins, dowel pin and snap ring combinations, socket head cap screws, etc., which still enable the bolt-cutting tool to be easily disassembled. In other alternate embodiments, the separate portions of the bolt-cutting device may be permanently attached.

In the present embodiment, handles 101 are of a cylindrical design and approximately five inches in length and one half-inch in diameter (5″×½″). However, in alternate embodiments, the size and shape of the handles may vary. For example, without limitation, one alternate embodiment may comprise handles with square cross sections. In the present embodiment, flat-planed tabs 115 extend perpendicularly from the top portions of handles 101. Flat-planed tabs 115 are approximately one half-inch (½″) in length and attach to each other by a bolt and nut 117. Handles 101 each resemble the letter “L”. Sleeves 103 encase handles 101 for approximately four and one-half inches (4½″) of their length. Sleeves 103 are of separate ergonomic designs, in order to be comfortable on the hands of a user. One of encasing sleeves 103 features finger indentations 119 while the second sleeve 103 has an arched sidewall 121; arched sidewall 121 accommodates the curve of the user's palm. These ergonomically designed handles 101 and sleeves 103 enhance the grip a user can comfortably apply upon handles 101 and are designed for ambidextrous use and multiple position functionality by either the left or right hand of the user. The functional options are such that with either the right or left hand, handles 101 can be gripped with palms facing in either a downward or upward position. This allows greater flexibility in enabling the user to cut the anchor bolt properly. Sleeves 103 are preferably made of a low-density polyethylene (LDPE); however, sleeves of various different materials may be used including, but not limited to, rubber or other types of plastic. In alternate embodiments, the sleeves may be made in various different patterns and designs, may be produced in various colors, and may bear images and/or logos, which may or may not be of registered trademark and/or copyright status. For example, without limitation, one alternate embodiment may comprise two sleeves with arched sidewalls and no sleeve with finger indentations. Other alternate embodiments may comprise sleeves with a rough texture for added grip. Yet other alternate embodiments may not feature ergonomic sleeves upon the handles. In embodiments that do not comprise ergonomic sleeves, the handles may have ergonomic shapes such as, but not limited to, a curved shape or a shape including finger indentations.

FIG. 2 is diagrammatic front view of an exemplary head portion of a bolt-cutting tool, in accordance with an embodiment of the present invention. In the present embodiment, a two-piece head 107 comprises two arced segments 200, the rounded walls of which form the exterior sidewalls of the head portion, and which attach to each other at an interior-center pivot point lever 111. This head portion is approximately one and one half inches in total length; however, the head portions in alternate embodiments may be larger or smaller. In the present embodiment, interior blades 201 of the craw formed by two-piece head 107 feature indentations 109 in lateral alignment to each other that form an open diamond shape when the craw is closed. Located near the bottom edge of each segment of head 107 is an aperture. These apertures enable each segment of head 107 to be attached the center fulcrum by a bolt and nut 113.

Blades 201 within the craw of head 107 of the bolt-cutting tool can be directly applied upon anchor bolts from two points. Diamond-shaped indentations 109 enable blades 201 to completely grip an anchor bolt on many points, not just on one point on one side as with a saw blade. Thus, diamond-shaped indentations 109 generally ensure that blades 201 maintain proper frictional contact upon anchor bolts with limited risk of slippage as pressure is applied and with limited risk of damage to the anchor bolts, making the bolt-cutting tool easier to apply upon anchor bolts than bladed saws. Pivot point lever 111 upon head 107 of the bolt-cutting tool can improve the force applied upon anchor bolts with minimum hand pressure, as well as generally ensure an even distribution of such force from both head blades 201. Furthermore, pivot point lever 111 generally ensures alignment of blades 201, which generally ensures an even cut upon anchor bolts without damaging the anchor bolts.

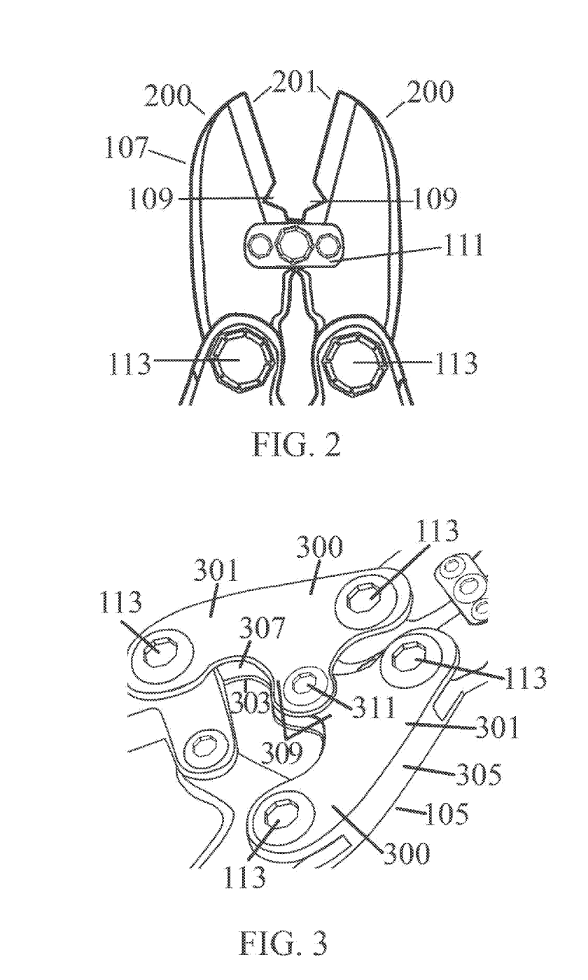

FIG. 3 is a top perspective view of an exemplary center fulcrum point portion of a bolt-cutting tool, in accordance with an embodiment of the present invention. In the present embodiment, a two-piece fulcrum 105 comprises two specially designed separate but attachable pieces 300, each of which measures an approximate two inches in length by three-quarters of one inch in width by one half inch in depth (2″×¾″×½″). In alternate embodiments the fulcrum pieces may vary in size. Each piece 300 has a top surface 301 and a bottom surface 303 as well as one side wall 305; this design creates a channel 307 into which the handles and the head segments may be inserted for attachment to fulcrum 105. Near-centered arms 309 extend from the interior plane of each fulcrum piece 300 to enable pieces 300 to be attached to one another by a nut and bolt 311 through included apertures. This connection point acts as a “pivot point.” Apertures for insertion of nuts and bolts 113 are featured upon the all endpoints of center fulcrum pieces 300 to enable two-piece fulcrum 105 to be attached to the handles and the head portion of the bolt-cutting tool. Two-piece fulcrum 105, which separates the handles of the bolt-cutting tool from the head, allows for adequate tension to be applied upon anchor bolts

In typical use of the present embodiment, a user may apply the bolt-cutting tool upon the anchor bolts of a toilet during the appropriate stage of its installation. By fitting an anchor bolt in alignment to diamond-shaped indentations 109 of the craw, the user can squeeze handles 101 and move head 107 back and forth to cut the anchor bolt at a desired point. The user can then apply a china cap over the newly trimmed anchor bolt to provide the decorating appearance desired with no visual interruption. The bolt-cutting tool can cut any extending lengths of anchor bolts used to mount a floor toilet. Should any portion of the bolt-cutting tool become damaged or worn, that portion can be easily removed by loosening the appropriate nut-bearing bolts 113 at the connection points of that portion to other portions of the device. A replacement portion can then be installed. The design of the bolt-cutting tool according to the present embodiment enables the tool to be fully opened and closed with just one hand. This design makes the bolt-cutting tool good for working in tight quarters, where toilet anchor bolts are usually found. This design also generally ensures that the user can cut an anchor bolt with minimal pressure from one hand's grip, such that if the bolt-cutting tool is properly used great squeezing strength is not required.

A preferred step-by-step description of how best to use the bolt-cutting tool according to the present embodiment is described in the following. The user first investigates the cutting environment and determines how best to utilize the bolt-cutting tool, for example, without limitation, with the use of a right or left hand and with the palm up or down. After deciding on the best approach to proceed, the user grips the bolt-cutting tool in the chosen hand with the desired palm position and then maneuvers head 107 of the bolt-cutting tool into position to “slightly grab” the exposed anchor bolt within diamond-shaped indentations 109 located in the craw of head 107. The location where the user “slightly grabs” the anchor bolt is not yet critical, as adjusting the placement of the bolt-cutting tool on the anchor bolt is easy to accomplish. With the anchor bolt slightly ‘grabbed’ by the bolt-cutting tool, the user, while maintaining a slight opening of the craw, can properly move the bolt-cutting tool up or down to the point where the anchor bolt is to be cut. This up or down movement does not damage the exposed threading of the anchor bolt because the craw is slightly opened and diamond-shaped indentations 109 provide room for risk-free adjustment. By not damaging the bolt(s), future removal of the toilet, china cap and/or nut is made easier than if the anchor bolt is damaged, which may occur with other cutting techniques.

The relatively short head portion and diamond-shaped indentations 109 in blades 201 of the bolt-cutting tool provide easy access to anchor bolts in practically any toilet design and with the possible close proximity of bathroom walls or other fixtures. As a toilet installer is likely to be working in a tight area, the concern with longer blades without diamond-shaped indentations is that when the user applies force, the exposed anchor bolt may slip out of the craw of the tool, resulting in an improper cut, no cut at all and/or damage to the anchor bolt(s). With short blades and diamond-shaped indentations, as in the present embodiment, the user can position the anchor bolt to be restricted inside the open area created by diamond-shaped indentations 109 so that the anchor bolt cannot slip away from the bolt-cutting tool as the necessary force is applied to cut the anchor bolt at the desired height. Furthermore, the bolt-cutting tool in accordance with the present embodiment is smaller in size than the bladed saws normally used to trim anchor bolts, which makes the use of this tool much easier and more convenient especially in environments of limited space.

Once the bolt-cutting tool is positioned at the desired cutting point, the user squeezes handles 101 while performing a slightly back and forth motion with the bolt-cutting tool. The squeezing of handles 101 along with the slight back and forth motion generally ensures a clean and precise cut on the anchor bolt. The center fulcrum section of the bolt-cutting tool not only holds the tool together, it also enables the user to apply enough leverage and torque in order to cleanly cut the anchor bolt with a small squeeze of their hand. Furthermore, handles 101 account for the vast majority of the length of the bolt-cutting tool, and such is designed to provide additional leverage so the user can easily cut the anchor bolt with a small squeeze of their hand.

Instead of having to hack away at anchor bolts with a saw or other device, the bolt-cutting tool according to the present embodiment enables anchor bolts to be easily and cleanly cut in very little time. The bolt-cutting tool produces virtually no metal shrapnel, cutting dust or other messiness about its area of use, unlike saws. This generally eliminates the risk of rust stains upon a porcelain toilet, which can result from shrapnel or cutting dust of anchor bolts when saws are used to reduce their length. The use of the bolt-cutting tool to trim anchor bolts requires practically no clean up after usage. The use of bolt-cutting tool also reduces the labor time and costs required to trim anchor bolts, as well as the costs of that labor. The use of the bolt-cutting tool therefore reduces the time that a user must remain in an uncomfortable position while accessing areas in hard-to-reach locations of limited space. This can reduce the physical stress and pains to which users would ordinarily be subject while in such uncomfortable positions.

Furthermore, the bolt-cutting tool generally eliminates the common risk of unintentional contact upon a toilet and upon items surrounding a toilet, such as but not limited to walls, woodwork, flooring and cabinets, which can commonly occur when saws are used to trim anchor bolts. This generally prevents damages and undesired markings from blemishing toilets and their surround areas and generally eliminates the costs of repair and/or replacement due to such damages, as well as the time lost by such repair and/or replacement. Add to these benefits the fact that many Americans install new toilets or completely new bathrooms with or without the aid of a plumber, and it is easy to see why the present embodiment can appeal to many consumers.

By being attached to each other by nuts and bolts, the individual portions of the bolt-cutting tool according to the present embodiment can be easily disassembled when necessary. The separate portions of the bolt-cutting tool can be sold separately for replacement when needed. The ability to purchase replacement parts as needed and then to be able to easily change out such parts enables the bolt-cutting tool to remain usable at a reduced cost in comparison to complete replacement. For example, without limitation, with prolonged use blades 201 may become dull, break or may become otherwise unusable. With the modularity of the present embodiment, blades 201 may be removed from fulcrum 105 and new blades may be attached to fulcrum 105 in their place.

In an alternate embodiment of the present invention, a bolt-cutting tool does not include a separate fulcrum portion. In this embodiment, bolt-cutting tool comprises two handles with or without ergonomic sleeves and a two-piece head with blades having diamond-shaped indentations of lateral alignment within the craw that attach to the handles.

Those skilled in the art, in light of the present teachings, will readily recognize that various other modifications may be included in other alternate embodiments of the present invention. For example, without limitation, some alternate embodiments may be made in various sizes and shapes of intended applicability. Some alternate embodiments may include various images and/or logos, which may or may not be of registered trademark and/or copyright status.

Having fully described at least one embodiment of the present invention, other equivalent or alternative methods of providing a bolt-cutting tool according to the present invention will be apparent to those skilled in the art. The invention has been described above by way of illustration, and the specific embodiments disclosed are not intended to limit the invention to the particular forms disclosed. For example, the particular implementation of the head may vary depending upon the particular type of pivot mechanism used. The pivot mechanisms described in the foregoing were directed to pivot point lever implementations; however, similar techniques are to use different types of pivot mechanisms for the head such as, but not limited to, a single pivot point about a bolt or pin. Implementations of the present invention comprising various different types of pivot mechanisms for the head are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
means for operating the apparatus in which the operating means are rotatably joined;
means for transferring a rotational force from the operating means;
means for forming a craw joined to the transferring means and operable for engaging an anchor bolt of a floor toilet; and
means for generally aligning the craw and transferring forces from the transferring means to a cutting force on the anchor bolt where a length of the anchor bolt can be cut while mitigating damage to a thread of the anchor bolt.

2. An apparatus comprising:
a pair of handles for operating the apparatus in which each handle comprises a length for grasping and a flat-planed tab extending perpendicularly from a top of the handle, the handles being rotatably joined proximate distal ends of the flat-planed tabs;
a two-piece fulcrum for transferring a rotational force from the pair of handles in which each piece comprises a bottom portion for rotatably joining to a one of the pair of handles proximate a proximal end of the flat-planed tab, a top portion and a near-centered arm extending perpendicularly from the piece, the pieces being rotatably joined proximate distal ends of the near-centered arms;
a two-piece head for forming a craw in which each piece comprises a bottom portion rotatably joined to the top portion of one piece of the two-piece fulcrum and an interior blade having an indentation operable for engaging an anchor bolt of a floor toilet; and
a pivot point lever for rotatably joining the pieces of the two-piece head, generally aligning the interior blades and transferring forces from the two-piece fulcrum to a cutting force on the anchor bolt where a length of the anchor bolt can be cut while mitigating damage to a thread of the anchor bolt.

3. The apparatus as recited in claim 2, in which each piece of the two-piece fulcrum further comprises a top surface, a bottom surface and one side wall forming a channel into which a handle and a head piece may be inserted for joining.

4. The apparatus as recited in claim 2, in which each piece of the two-piece head further comprises a rounded exterior sidewall.

5. The apparatus as recited in claim 2, in which the pivot point lever joins the pieces of the two-piece head below the indentation.

6. The apparatus as recited in claim 2, in which the indentations form a diamond shape when the craw is closed.

7. The apparatus as recited in claim 2, in which each handle further comprises a sleeve covering a portion of the length.

8. The apparatus as recited in claim 7, in which the sleeve comprises a low-density polyethylene.

9. The apparatus as recited in claim 7, in which the sleeve comprises an ergonomic shape.

10. The apparatus as recited in claim 9, in which the ergonomic shape comprises finger indentations.

11. The apparatus as recited in claim 2, in which bolts and nuts join the pieces.

12. The apparatus as recited in claim 11, in which the pieces are removable for replacement.

13. The apparatus as recited in claim 2, in which the pieces comprise an alloyed steel for mitigating rust corrosion.

14. An apparatus comprising:
a pair of handles for operating the apparatus in which each handle comprises a length for grasping, a sleeve covering a portion of the length and a flat-planed tab extending perpendicularly from a top of the handle, the handles being rotatably joined proximate distal ends of the flat-planed tabs;
a two-piece fulcrum for transferring a rotational force from the pair of handles in which each piece comprises a top surface, a bottom surface and one side wall forming a channel into which a one of the pair of handles is joined proximate a proximal end of the flat-planed tab, each piece further comprising a near-centered arm extending perpendicularly from the piece for rotatably joining the pieces proximate distal ends of the near-centered arms;
a two-piece head for forming a craw in which each piece comprises a bottom portion rotatably joined to the channel of one piece of the two-piece fulcrum, a rounded exterior sidewall and an interior blade having an indentation forming a diamond shape when the craw is closed and operable for engaging an anchor bolt of a floor toilet; and
a pivot point lever for rotatably joining the pieces of the two-piece head below the indentations, generally aligning the interior blades and transferring forces from the two-piece fulcrum to a cutting force on the anchor bolt where a length of the anchor bolt can be cut while mitigating damage to a thread of the anchor bolt.

15. The apparatus as recited in claim 14, in which the sleeve comprises a low-density polyethylene.

16. The apparatus as recited in claim 14, in which the sleeve comprises an ergonomic shape.

17. The apparatus as recited in claim 16, in which the ergonomic shape comprises finger indentations.

18. The apparatus as recited in claim 14, in which bolts and nuts join the pieces.

19. The apparatus as recited in claim 18, in which the pieces are removable for replacement.

20. The apparatus as recited in claim 14, in which the pieces comprise an alloyed steel for mitigating rust corrosion.
